(19) United States
(12) Patent Application Publication
(10) Pub. No.: US 2016/0373321 A1
(43) Pub. Date: Dec. 22, 2016

(54) SYSTEM, APPARATUS AND METHOD FOR MANAGING DEVICES

(71) Applicant: Andy Plaza, Long Valley, NJ (US)

(72) Inventor: Andy Plaza, Long Valley, NJ (US)

(73) Assignee: RICOH COMPANY, LTD., Tokyo (JP)

(21) Appl. No.: 14/740,912

(22) Filed: Jun. 16, 2015

(51) Int. Cl. H04L 12/26

(52) U.S. Cl. CPC H04L 43/04; H04L 43/0876; H04L 43/065

(57) ABSTRACT

Tools for managing a fleet of information technology devices can be configured to assist to determine whether a managed device should be replaced, such as based on a projected lifespan of the device, and can be configured to output recommendations of devices as replacements to the device that has reached the end of its lifespan.

### TECHNICAL FIELD

This disclosure relates to systems, apparatuses and methods that can employed when managing a fleet of information technology devices, and more specifically, tools (e.g., systems, apparatuses, application software, methodologies, etc.) which can be of assistance when determining whether a managed device should be replaced.

### BACKGROUND

In the current information age, information technology (IT) tools are extensively used in enterprises and other organizations in order to facilitate communication and processing of information, documents, data, etc. Indeed, it is now rare to find a workflow in an enterprise or organization that does not employ IT tools. The number of IT devices and assets [such as software, computers, printers, scanners, multi-function devices (MFDs), other network-connected or standalone devices, etc.] is generally increasing and, as a result, managing IT devices is becoming a daunting task.

While ten or twenty information technology devices (e.g., printers, scanners, fax machines, copiers, MFPs, computers, mobile devices, etc.) may be manageable, many organizations have a fleet of hundreds, or even perhaps thousands, of devices. Further, in some instances, the devices in the managed fleet are distributed over multiple offices or sites. Consequently, it can be difficult to manage the devices proactively, such as to replace devices as a device approaches the end of its lifespan. Waiting until a device breaks down without warning before obtaining a replacement may be an organizational problem, since device downtime tends to reduce efficiency and productivity in the organization. Further, such problem is exacerbated when the replacement is needed to attend to urgent matters.

There is a need for tools that help to predict when the lifespan of a device is near an end.

### SUMMARY

Various tools (e.g., systems, apparatuses, methodologies, computer program products, application software, etc.) for managing a fleet of information technology devices can be provided.

In an aspect of this disclosure, a device management apparatus (e.g., a terminal executing a device management application) configured to monitor and manage a fleet of information technology devices and collect device usage data from the information technology devices via a network can be additionally configured to assist to determine whether a managed device should be replaced. For example, the apparatus may be configured to include a device lifespan projection module (such as a computer program, or a group of instructions) which retrieves device usage data of a managed device and determines a projected lifespan of the device based on at least the retrieved device usage data.

For example, the managed device may be a device including a print engine, and in such example, the device lifespan projection module can determine the projected lifespan of the target device based on at least two of the device usage data (e.g., lifetime output count of pages printed by the print engine, total number of service calls to service the device, energy use by the device, consumables usage data, etc.).

In another aspect, the projected lifespan determined by the device lifespan projection module is a numerical lifespan index of the target device, and the device lifespan projection module compares the numerical lifespan index of the target device to a lifespan threshold. When the numerical lifespan index of the target device has reached the lifespan threshold, a recommendation to replace the target device is output (e.g., to a user, to an administrator, to a specified address, etc.).

In another aspect, the apparatus may be configured to determine, based on the device usage data, a replacement device model that is suitable as a replacement for the device, and outputs an indication of the replacement device model that is a suitable replacement for the target device along with the recommendation to replace the target device.

In another aspect, the apparatus may additionally include a user interface module that causes a lifespan message including the projected lifespan of the device to be output, when device information of the device is requested from a user terminal. Such numerical lifespan index may be presented in any of various useful ways. For example, the lifespan message may include an indication of a percentage of the lifespan of the target device remaining. In another example, the numerical lifespan index can be displayed for comparison with those of other devices amongst the fleet of devices.

In another aspect, when, upon request from a user, the user interface module outputs a usage report, a fleet summary report, a location-specific summary report, a vendor-specific summary report, a meter read report, etc., such report can be fashioned to include for each device having a numerical lifespan index that has reached the lifespan threshold, a recommendation to replace the device.

In another aspect, the user interface module can be configured to output, upon request, a web page through the network to the user terminal to cause a web browser application on the user terminal to provide a graphical user interface (GUI) on the user terminal, in which the lifespan message is provided through the GUI page.

In another aspect, the device management apparatus can be configured (e.g., as a server) to provide a device management application through the network to the user terminal, and the user interface module causes the device management application to provide a graphical user interface (GUI) on the user terminal, in which the lifespan message corresponding to the projected lifespan of the target device is provided through the GUI provided by the application.

### BRIEF DESCRIPTION OF THE DRAWINGS

The aforementioned and other aspects, features and advantages can be more readily understood from the following detailed description with reference to the accompanying drawings wherein:

FIG. 1 shows a block diagram of a system for managing a fleet of devices, according to an exemplary embodiment;

FIG. 2 shows an example of device usage data stored in a device database;

FIG. 3 shows a block diagram of an exemplary configuration of a computing device that can constitute a user terminal and that can be configured by software to constitute a device management apparatus;

FIG. 4 shows a block diagram of an exemplary configuration of a terminal that can constitute a user terminal;

FIG. 5 shows a block diagram of an exemplary configuration of a multi-function device that can constitute a managed device and that can constitute a user terminal;

FIG. 6 shows a flow diagram of a method performed by, for example, the device management apparatus shown in FIG. 1, according to an exemplary embodiment;

FIGS. 7A-7G show examples of user interface screens that can provided by the user interface module shown in FIG. 1;

FIG. 8 shows a flow diagram of a method performed by, for example, the device management apparatus shown in FIG. 1, according to another exemplary embodiment;

FIGS. 9A-9D show examples of reports that can provided by the user interface module shown in FIG. 1.

### DETAILED DESCRIPTION

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. In addition, a detailed description of known functions and configurations will be omitted when it may obscure the subject matter of the present invention.

In this disclosure, various device management tools are discussed and provisions for predicting or projecting lifespan of a device can be integrated therein to assist device administrators with the decision to replace the device. It should be appreciated by those skilled in the art that a device management tool can be provided in any of various ways and thus while various examples are discussed herein, the inventive subject matter of this disclosure is not limited to such examples described herein.

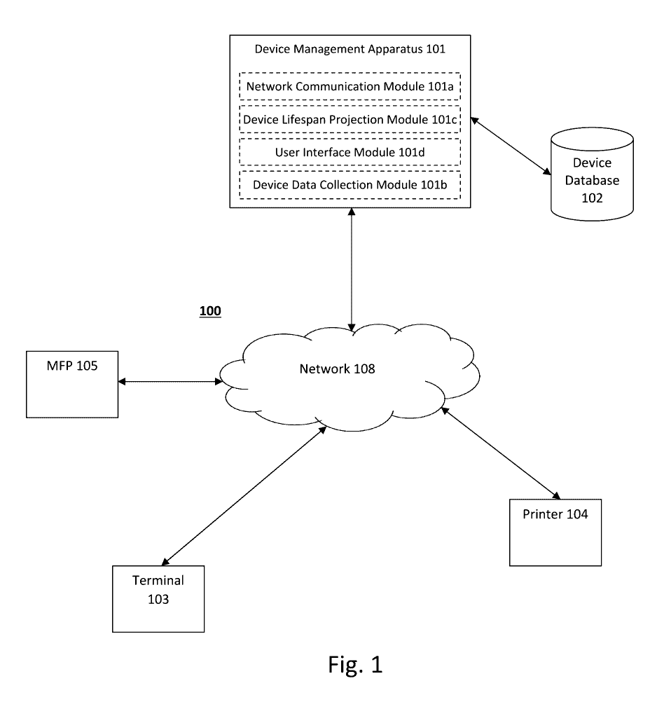

Referring now to the drawings, wherein like reference numerals designate identical or corresponding parts throughout the several views, FIG. 1 shows schematically an exemplary embodiment of a networked system 100 including various devices. The system 100 includes a device management apparatus 101, a device database 102, a terminal 103, a printer 104 and an MFP 105. The device management apparatus 101, the terminal 103, the printer 104 and the MFP 105 are interconnected by a network 108.

The term “MFP” is used herein generically to include any multifunction output device having a printing or plotting functionality and a copy and/or scanning functionality in addition to the printing or plotting functionality, as well as optionally various other functionalities (e.g., scan-to-email, scan-to-store, etc.).

The device management apparatus 101 includes a network communication module 101a, a device data collection module 101b, a device lifespan projection module 101c and a user interface module 101d.

The network communication module 101a communicates with a fleet of information technology devices (e.g., printer 104, MFP 105) connected to the network 108 to obtain, at predetermined regular intervals, device information (e.g., device properties, device usage data, etc.) corresponding to each device in the fleet. Such communication may be performed (for example, by way of an Ethernet connection or other network connection which supports any desired network protocol such as, but not limited to TCP/IP, IPX, IPX/SPX, or NetBEUI). The device information may include device properties (e.g., device name, serial number, MAC address, IP address, SAP address, model number, brand, manufacturer, etc.) and device usage data. The fleet of information technology devices may include a plurality of various types of devices (e.g., printers, scanners, copiers, fax machines, MFPs, etc.), each of which may be manufactured by different companies (e.g., “Ricoh”, “HP”, “Epson”, “Lexmark”, etc.) and be of different brands and models. In addition, each device within the fleet of devices may each be located a different physical location (e.g., different rooms, floors, buildings, etc.). For example, an “Aficio 521” printer produced by “Ricoh” may be located in an executive office of a building, while a “CX5000 MFP” manufactured by “Epson” may be located in a basement of the same building.

The device data collection module 101b coordinates with the network communication module 101a by extracting device usage data from the collected device information and storing the device usage data into the device database 102. Examples of device usage data may include data corresponding to characteristics of the device (e.g., device age, location, department, etc.), functions performed by the device (e.g., printing, scanning, copying, faxing, etc.), actions performed to maintain the device (e.g., service calls), resources used by the device (e.g., energy consumed, supply costs, etc.), etc. It should be noted that in an exemplary embodiment, device usage data of a particular device (e.g., printer 104, MFP 105, etc.) in the fleet of devices connected to the network 108 stored in the database 102 is not removed when the particular device is disconnected from the network 108. Instead, the device usage data of the particular device is stored in the device database 102 until (1) an administrator removes the device usage data of the particular device from the system and/or (2) a predetermined time (e.g., days, months, years, etc.) set by the administrator has passed. This is to prevent device usage data from being reset when disconnecting the particular device from the network 108 for a minor action (e.g., moving the particular device from one room to another, rebooting the particular device, etc.).

The device lifespan projection module 101c can access the device database 102 to retrieve or obtain device usage data for the fleet of managed devices and determines (e.g., calculates, categorizes, etc.) a predicted lifespan of a device based on the device usage data. The predicted (or projected) lifespan is a prediction of the remaining life of a device. In other words, while devices may be repairable in some instances when broken or non-functioning, the end of a lifespan is a point in time in which the device is no longer able to function (e.g., worn down as a result of continuous use) and it cannot be repaired or the cost repair exceeds the cost of replacement

As stated previously, the device usage data contains a variety of data which may be in different units (e.g., dollars, days, months, years, milliliters, etc.) and have different range of values (e.g., 0.1, 270, 45,300, etc.). Thus, each type of device usage data (e.g., energy consumed, number of copies, etc.) is scaled to a numerical value before calculations are performed. After each type of data is scaled to its respective scaled value, the device lifespan projection module 101c can calculate a numerical lifespan index by applying the scaled values in a mathematical formula [e.g., numerical lifespan index=f(x₀, x₁, x₂, . . . xₙ), where x are the scaled values and n is a positive integer].

Such numerical lifespan index may indicate a remaining life (e.g., 20% left) of the device or may show a stage of life of the device (e.g., new). Although the numerical lifespan index may be formulated based on plural device usage data, it is not necessary for the numerical lifespan index to be calculated based on all of the numerical values of the device usage data. In other words, the numerical lifespan index may be calculated based on at least two types of device usage data (e.g., number of service calls and age of device).

The numerical lifespan index may also be compared with a lifespan threshold which may be used to specify that the device is nearing the end of its life. Such lifespan threshold may be determined by the manufacturer of the device or an administrator. In a case that the numerical lifespan index reaches or passes the value of the lifespan threshold, the device management apparatus 101 outputs a message to a user (e.g., administrator) indicating that (1) the device is reaching the end of its life and (2) a recommendation of one or more replacement devices. The device lifespan projection module 101c may select the one or more recommended replacement devices based on the device information (including device usage data) corresponding to the particular device that is to be replaced. For example, the particular device may be used to perform color printing frequently. As a result, the lifespan projection module 101c may search, via a database or Internet, for one or more printers which specialize in color printing (e.g., high quality at a lower cost) and recommend them to the user.

The user interface module 101d may present to the user, via a graphic user interface (GUI) on the terminal 103, with an option to request device information (including device usage data) regarding each device in the fleet of information technology devices. For example, such user may request a report on device data usage for a single device within the fleet, a subset of devices within the fleet or the entire fleet itself. Further, for each time that the user requests device data usage information for one or more particular devices, the device lifespan projection module 101c may calculate the numerical lifespan index corresponding to each of the selected one or more particular devices which is then displayed to the user by the user interface module 101d. In addition, as stated previously, in a case that the numerical lifespan index reaches or passes a lifespan threshold, a message is outputted to the user via the user interface module 101d indicating (1) that the device is nearing the end of its life and (2) a recommendation of one or more replacement devices.

The device database 102 is a database that stores device usage gathered by the network communication module 101a and the device data collection module 101b from each device of the fleet of information technology devices connected to the network 108. Further, the device database 102 allows the device lifespan projection module 101c to access device usage data stored in the device database 102, to calculate the numerical lifespan index.

The terminal 103 may include a processing unit and a display unit, where the processing unit executes an application to cause the display unit to display the user interfaces provided by the device management apparatus 101. The terminal 103 is further described infra with reference to FIG. 4.

The terminal may be used by a user (such as an administrator) to view device usage data corresponding to devices connected to the network 108. Further, the terminal may be used to access, via a browser which is a program on the terminal 103, to the Internet and/or e-mail.

It should be appreciated that while only the terminal 103 is shown in the example of FIG. 1, the system 100 can include more terminals. Indeed, the document management system of this disclosure is preferably configured to be scalable such that terminals can be added to the system as desired and needed (e.g. to serve more users).

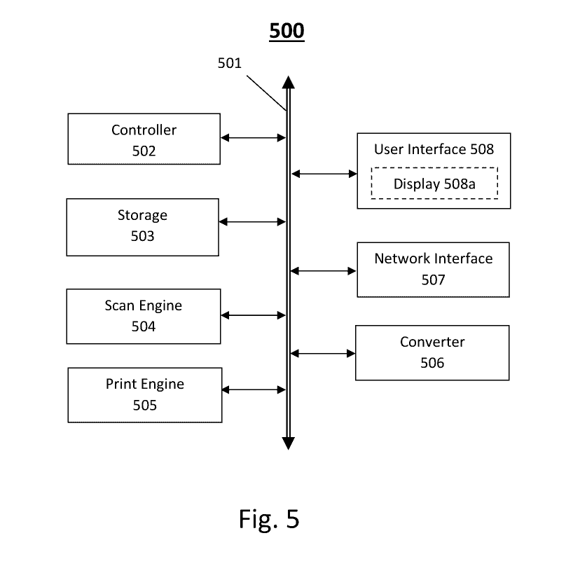

The MFP 105 can be, for example a printer/scanner, printer/scanner/fax, etc. While this example of this disclosure simply refers to a single MFP 105 and a single printer 104 in the interest of brevity, it should be appreciated that the network environment can have an arbitrary number of printer and MFP devices. The MFP 105 may be configured as shown in FIG. 5 which is discussed infra.

The network 108 can be a local area network, a wide area network or any type of network such as an intranet, an extranet (for example, to provide controlled access to external users, for example through the Internet), a private or public cloud network, the Internet, etc., or a combination thereof. In addition, the network 108 preferably uses TCP/IP (Transmission Control Protocol/Internet Protocol), but other protocols such as SNMP (Simple Network Management Protocol) and HTTP (Hypertext Transfer Protocol) can also be used. How devices can connect to and communicate over networks is well-known in the art and is discussed for example, in “How Networks Work”, by Frank J. Derfler, Jr. and Les Freed (Que Corporation 2000) and “How Computers Work”, by Ron White, (Que Corporation 1999), the entire contents of each of which are incorporated herein by reference.

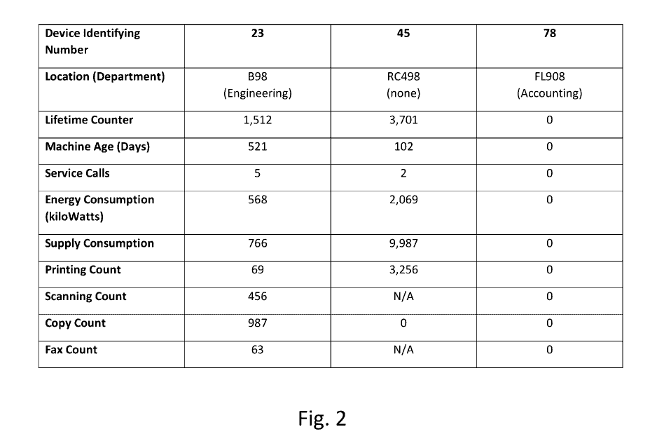

FIG. 2 shows a table representing an example of device usage data in a device database (e.g., device database 102) which includes various types of device usage data associated with each device in the fleet of information technology devices.

The lifetime counter, stored as lifetime counter data, is the number of times that the device has performed an operation that utilized an intensive mechanical process. For example, when performing printing and copying, a device utilizes various moving parts thereby causing wear and tear in said moving parts. Thus, operations involving scanning are not included in the lifetime counter data since scanning does not require a mechanical process that is demanding. The lifetime counter data can be set in a plurality of ways. For example, a tally of the lifetime counter data may accrue for each sheet of paper that is printed or copied. In another example, the tally of the life time counter data may accrue for each print job or copy job performed.

Machine age, stored as machine age data in the device database, is the total amount of time (e.g., days, months, years, etc.) in which the device has been in use. For example, the device may have been connected to a network and utilized since Jan. 31, 2009. Thus, assuming the device has been continuously operating since then, a report on Feb. 1, 2015 regarding the device usage data of the device would indicates that the age of the device would be 6 years and 1 day. It should be noted, however, that in an exemplary embodiment, the age is only calculated when the device is in use. In other words, when the device is not in operation (e.g., moving from one building to another), the counter for counting the age stops. In another exemplary embodiment, the age is calculated even when the device is disconnected from the network. In this case, the machine age data includes, in addition to the overall age of the device, the amount of time that the device was not connected to the network or in service. Knowing the age of the device can assist in predicting whether the device is nearing the end of its life. As is widely known, many manufacturers set a predicted lifespan (e.g., 20 years) of their devices. Thus, when a device reaches a certain age (e.g., 19 years) that is close to the predicted lifespan set by the manufacturer, a user of the device may recognize that the device is about to be nearing the end of its life.

Supply consumption, stored as supply consumption data in the device database, is the total amount of concrete resources (e.g., ink, paper, staples, etc.) that is used by the device over a period in its lifetime. The supply consumption data may be divided into subsets of data according to resource type. For example, supply consumption data corresponding to ink is stored as the amount of millimeters of ink consumed, while supply consumption data corresponding to paper is stored as the number of sheets used by the device. In addition, the subsets of data may be further divided as necessary. For example, the ink supply consumption data may be divided into colors (e.g., magenta, cyan, yellow, black, etc.) consumed. The value of the supply consumption data is that it assists in determining how intensively the parts of the device are used. For example, when performing printing, a user may select to print using options that generate a high quality image thereby causing the printer to utilize more resources and perform printing at a higher intensity than a normal print job. However, while more resources are consumed, there is no indication of this since such printing counts as a single print job. Thus, the supply consumption data allows a use to recognize that the print jobs being performed are resource consuming and intensive. It should be noted, however, that when the user requests a report on the device usage data, the supply consumption data value may be presented as a single value. Such value is calculated based off the values of each of the subsets of data (e.g., ink, paper, staples).

Energy consumption, stored as energy consumption data, is total amount of electricity consumed by the device. Such energy can be stored in units of watts (or kilowatts) and depends on the model of the device. In other words, different models may have different energy requirements. The energy consumption data can indicate how much the device is being used relative to a time period. For example, high energy consumption can indicate that the device is being used frequently. On the other hand, high energy consumption can also indicate that the device is being turned on all the time thereby wasting energy.

Service calls, stored as service calls data in the device database, is the total amount of time in which a repair person comes to fix the device when it is not operating normally. When an issue is serious enough to warrant contacting such repair person, a tally may accrue automatically by a system residing inside the device when the repair person performs a specific action to the device. For example, there may be a sensor that activates only when a portion of the device is opened. Further, the portion can only be opened by a repair person and is only opened in case of serious issues. It should be noted that the tally for service calls accrue regardless of the type of service call (e.g., broken printer, inaccurate scanning, non-responsive display, etc.). As long as the repair person performs a specific action to cause the system to sense the repair person, the tally will accrue. The significance of such tally is that it assists in informing the user whether the device is nearing the end of its life or is defective. For example, a device, after operating for nearly 10 years without minimal to no service calls, may start to receive a copious amount of service calls within a very short time period, which may indicate that the device is nearing the end of its life. On the other hand, a device operating only for one month but receiving an abundance of service calls within that same month may qualify as being defective.

Printing count, stored as printing count data in the device database, is the number of times that a sheet of paper is printed or a print job is performed. Scanning count, stored as scanning count data in the device database, is the number of times that scanning of a single sheet is performed (e.g., scanning a 25 pages of a book amounts to 25 times accrued in the tally). Copy count is the number of times that copying of a single sheet is performed (e.g., copying 3 pages in a book amounts to 3 times accrued in the tally). Faxing count is the number of times that faxing is performed or received.

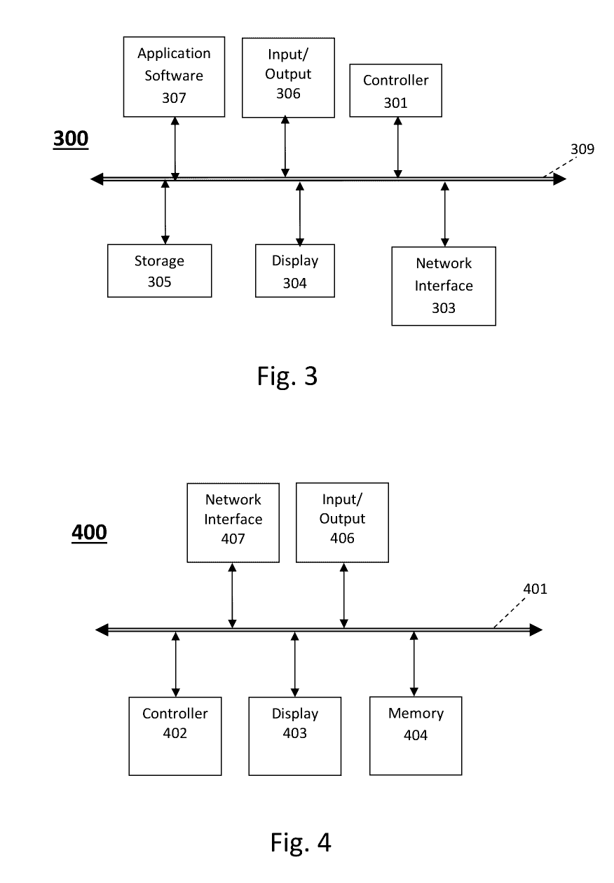

FIG. 3 shows an exemplary constitution of a computing device that can be configured (for example, through software) to operate (at least in part) as the device management apparatus 101 of FIG. 1. As shown in FIG. 3, apparatus 300 includes a controller (or central processing unit) 301 that communicates with a number of other components, including network interface 303, display 304 and memory or storage part 305, input/output (such as keyboard, mouse, touchpad, stylus, microphone and/or speaker with voice/speech interface and/or recognition software, etc.) 306, by way of a system bus 309. The management apparatus 300 may further include application software 307 and may be a special-purpose device (such as including one or more application specific integrated circuits and/or plural conventional components or circuits) or it may be software-configured on a conventional personal computer or computer workstation with sufficient memory, processing and communication capabilities to operate as a terminal and/or server, as will be appreciated to those skilled in the relevant arts.

In the management apparatus 300, the controller 301 executes program code instructions that control device operations. The controller 301, network interface 303, display 304, memory/storage 305 and input/output 306 are conventional, and therefore in order to avoid obfuscating the inventive aspects of this disclosure, such conventional aspects will not be discussed in detail herein.

The management apparatus 300 includes the network interface 303 for communications through a network, such as communications through the network 108 with the terminal 103 in FIG. 1. However, it should be appreciated that the subject matter of this disclosure is not limited to such configuration. For example, the management apparatus 300 may communicate with client terminals through direct connections and/or through a network to which some components are not connected. As another example, the management apparatus 300 does not need to be provided by a server that services terminals, but rather may communicate with the devices on a peer basis, or in another fashion.

An exemplary constitution of the terminal 103 of FIG. 1 (for example, as a computer) is shown schematically in FIG. 4. In FIG. 4, terminal 400 includes a controller (or central processing unit) 402 that communicates with a number of other components, including display 403, memory 404, input/output (such as keyboard, mouse, touchpad, stylus, microphone and/or speaker with voice/speech interface and/or recognition software, etc.) 406 and network interface 407, by way of an internal bus 401.

The memory 404 can provide storage for program and data, and may include a combination of assorted conventional storage devices such as buffers, registers and memories [for example, read-only memory (ROM), programmable ROM (PROM), erasable PROM (EPROM), electrically erasable PROM (EEPROM), static random access memory (SRAM), dynamic random access memory (DRAM), non-volatile random access memory (NOVRAM), etc.].

The network interface 407 provides a connection (for example, by way of an Ethernet connection or other network connection which supports any desired network protocol such as, but not limited to TCP/IP, IPX, IPX/SPX, or NetBEUI) to the network to which the terminal 400 is connected (e.g. network 108 of FIG. 1).

Additional aspects or components of the terminal 400 are conventional (unless otherwise discussed herein), and in the interest of clarity and brevity are not discussed in detail herein. Such aspects and components are discussed, for example, in “How Computers Work”, by Ron White (Que Corporation 1999), and “How Networks Work”, by Frank J. Derfler, Jr. and Les Freed (Que Corporation 2000), the entire contents of each of which are incorporated herein by reference.

FIG. 5 shows a schematic diagram of a configuration of a printing device as an MFP (multi-function printer or multi-function peripheral), which can be any apparatus (including a microprocessor chip or a collection of devices having varying degree of integration) that has the ability to perform two or more functionalities.

The MFP 500 shown in FIG. 5 includes a controller 502, and various elements connected to the controller 502 by an internal bus 501. The controller 502 controls and monitors operations of the MFP 500. The elements connected to the controller 502 include storage 503 (for example, random access memory, read-only memory, hard disk drive, portable storage media drive such as for optical discs, magnetic discs, magneto optical discs, etc., semiconductor memory cards, combinations of storage media, etc.), scan engine 504, print engine 505, converter 506, a network interface (I/F) 507 and a user interface (also referenced herein as “input/output” or I/O, such as keyboard, mouse, touchpad, stylus, microphone and/or speaker with voice/speech interface and/or recognition software, etc.) 508.

Storage 503 can include one or more storage parts or devices [e.g. a read only memory (for example, ROM, PROM, EPROM, EEPROM, etc.), a random access memory (RAM), a hard disk drive (HDD), portable media (for example, floppy disk, optical disc, magnetic discs, magneto-optical discs, semiconductor memory cards, etc.) drives], and program code instructions can be stored in one or more parts or devices of storage 503 and executed by the controller 502 to carry out the instructions. Such instructions can include instructions for performing specified functions (such as printing, scanning, faxing, copying, e-mailing, etc.) of the MFP 500, to enable the MFP 500 to interact with a terminal, as well as perhaps other external devices, through the network interface 507, and interactions with users through the user interface 508.

The network interface 507 is utilized by the MFP 500 to communicate with other network-connected devices such as a terminal or a server (e.g., the device management apparatus 101 of FIG. 1) and receive data requests, print jobs, user interfaces, and etc.

The user interface 508 includes one or more electronic visual displays that display, under control of controller 502, information allowing the user of the MFP 500 to interact with the MFP 500. The electronic visual display can be any of various conventional displays (such as a liquid crystal display, a plasma display device, a cathode ray tube display, etc.), but preferably is equipped with a touch sensitive display (for example, liquid crystal display) and is configured to provide a GUI (graphical user interface) based on information input by an operator of the MFP 500, so as to allow the operator to interact conveniently with services provided on the MFP 500, or with the MFP 500 serving as terminal for accessing electronic data or other content through the network. User interfaces or other contents received through the network via the network interface 507 can be displayed on the display screen.

The display screen does not need to be integral with, or embedded in, a housing of the MFD 500, but may simply be coupled to the MFD 500 by either a wire or a wireless connection. The I/O 508 may include keys and/or buttons (such as graphical keys or buttons, or other graphical elements, of a GUI on a touchscreen display) for inputting information or requesting various operations. Alternatively, the I/O 508 and the display screen 508a may be operated by a keyboard, a mouse, a remote control, voice recognition, or eye-movement tracking, or a combination thereof.

The scan engine 504, print engine 505, and network interface 507 are otherwise conventional, and therefore, a detailed description of such conventional aspects is omitted in the interest of clarity and brevity.

The MFP 500 can have any or all of the functions of similar devices conventionally known, such as for scanning, editing and storing images, sending a fax, sending and receiving e-mails with or without attachments, accessing files by FTP or another protocol or facility, surfing the Web, etc. Further, multi-functional devices or multifunction peripheral devices can play a prominent role to convert hardcopy documents to electronic documents.

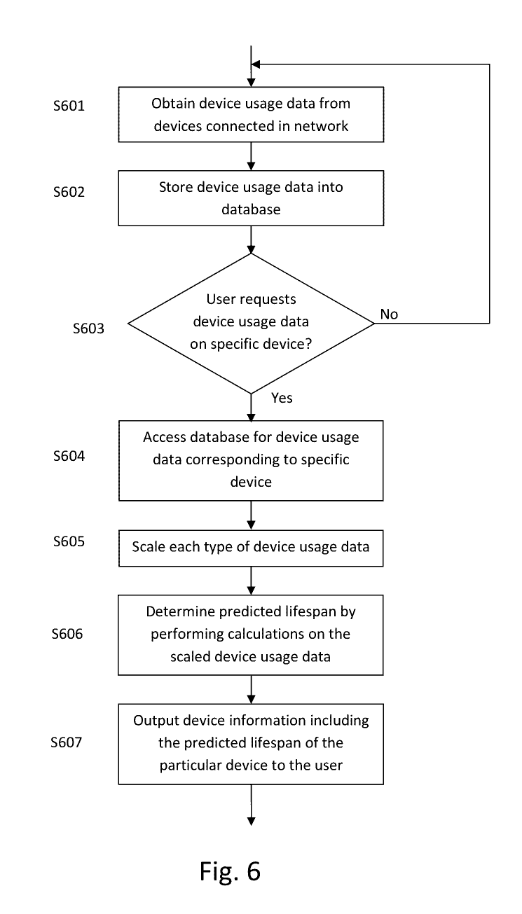

FIG. 6 shows a method that can be performed by a device management apparatus (e.g., 101 in FIG. 1), for determining a projected lifespan of one or more devices and presenting said projected lifespan to a user, according to an exemplary embodiment.

In organizations, there may be a fleet of managed devices (e.g., printers, scanners, fax machines, copiers, MFPs) connected to a network (e.g., network 108), and in such case, a device management apparatus (e.g., device management apparatus 101 of FIG. 1) may periodically obtain device usage data from each respective device in the fleet of devices (step 601). After obtaining the device usage data from each of the devices connected to the network, the device management apparatus may store the device usage data in a database that is inside or connected to the device management apparatus (step S602).

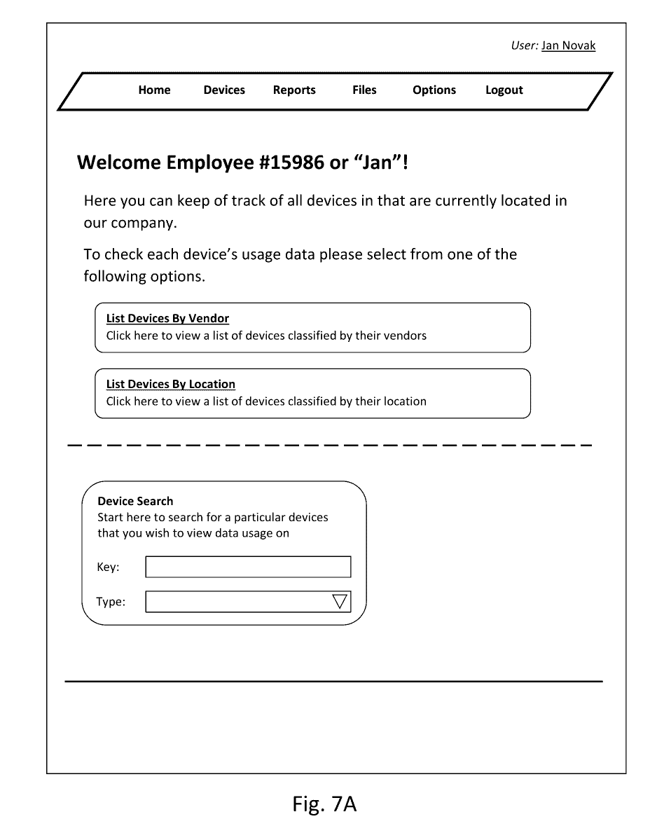

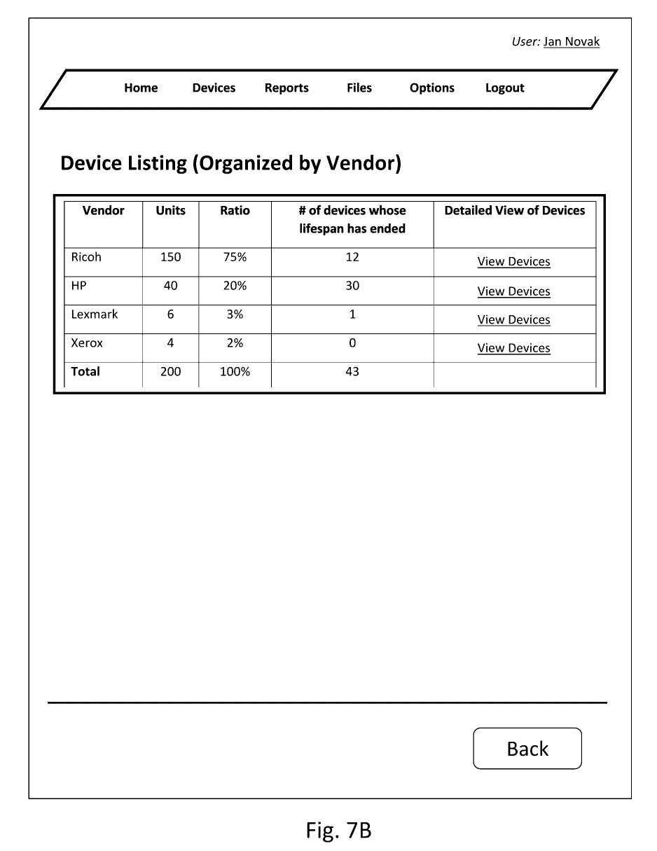

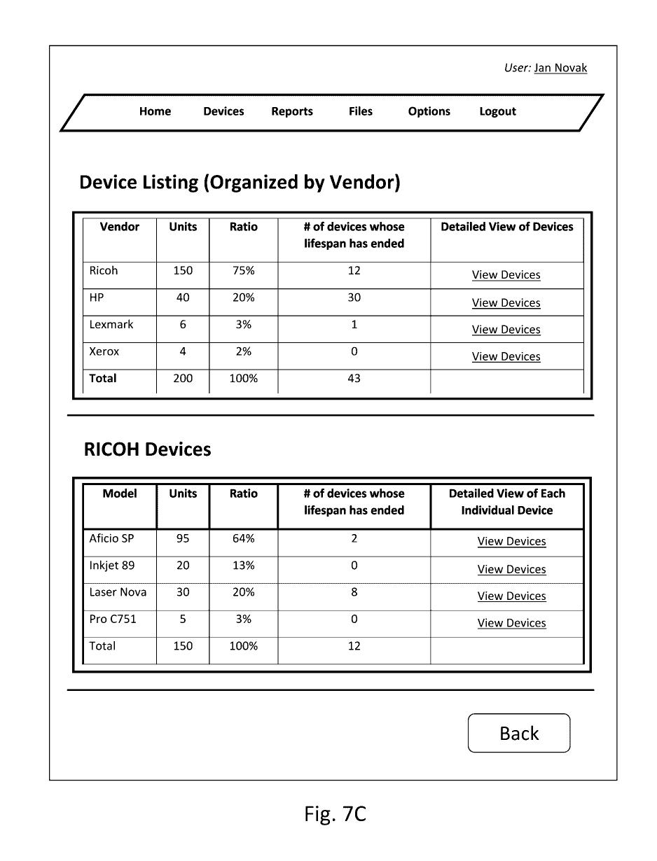

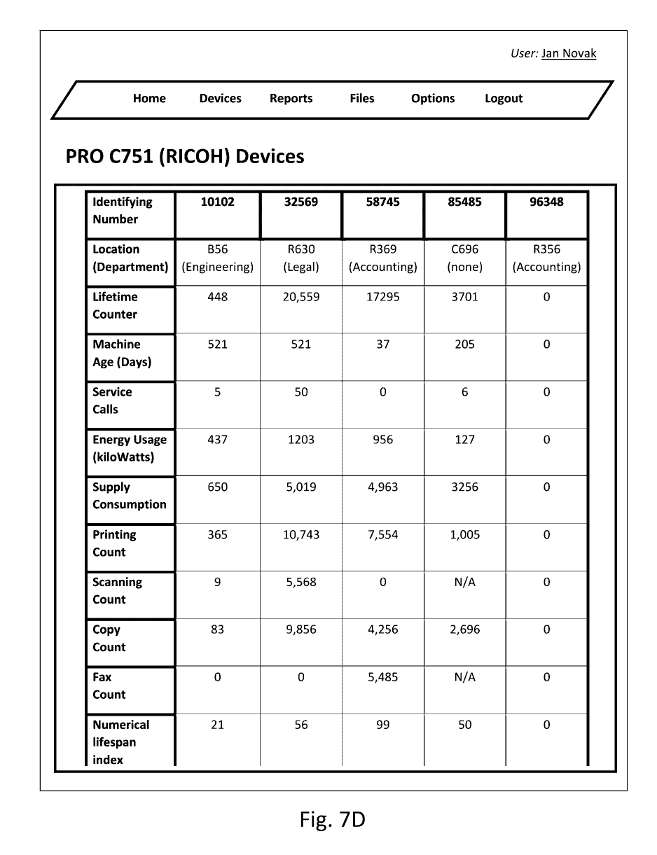

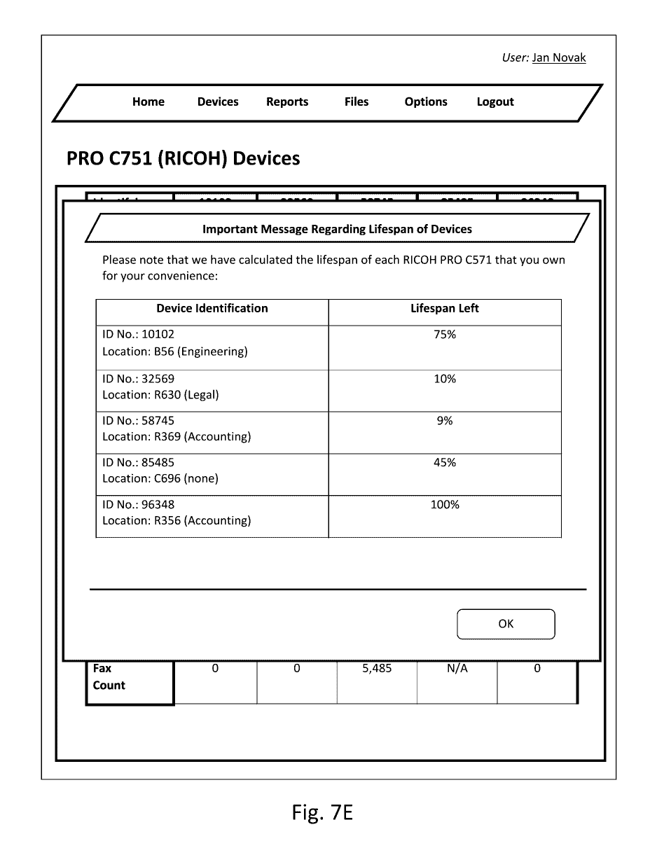

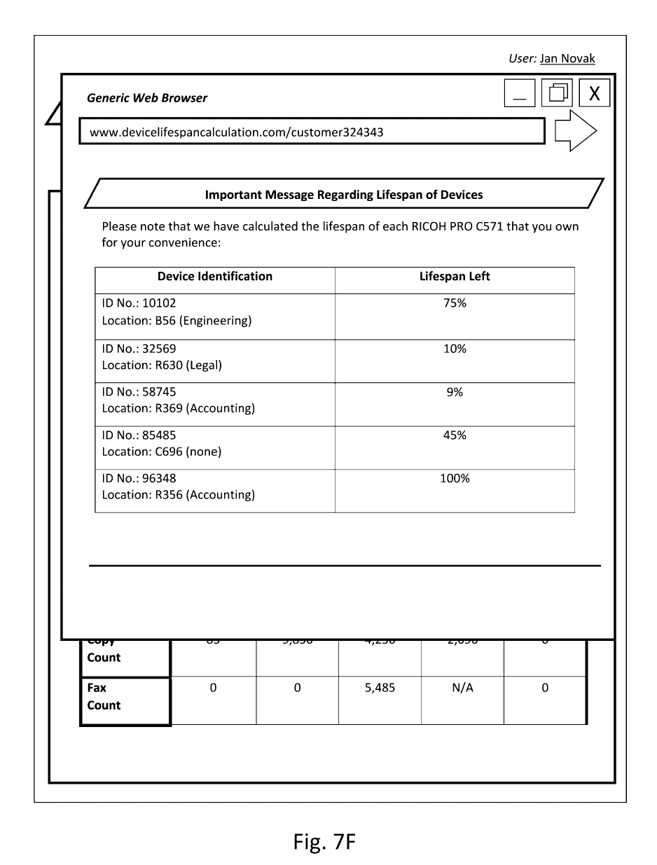

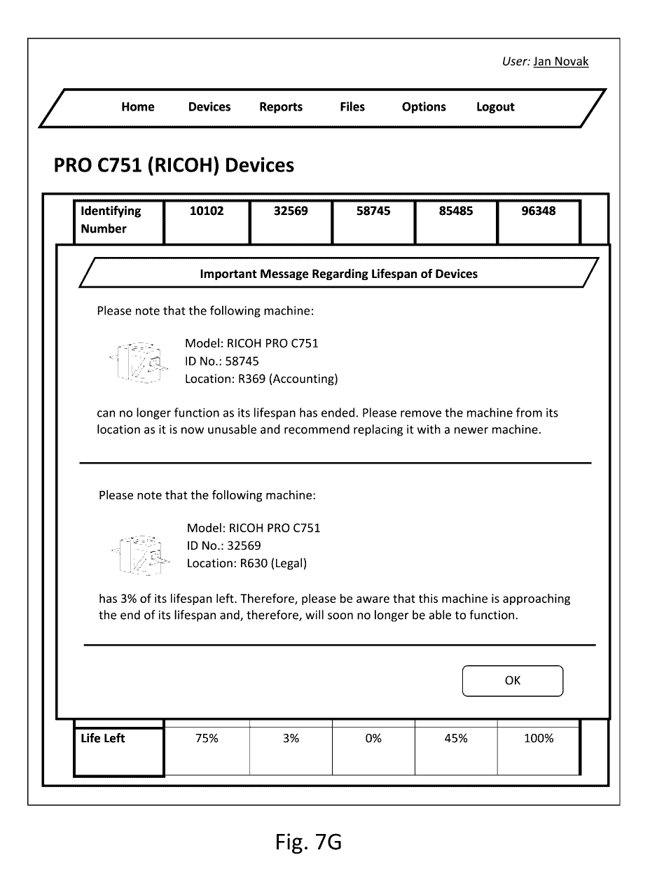

After storing the device usage data, the device management apparatus may determine whether a user, such as an administrator, wishes to view the device usage data collected by the device management apparatus (step S603). In the case that there is no request (step S603, no), the device management apparatus may obtain and update periodically device usage data from devices connected to the network. On the other hand, in the case that there is a request (step 603, yes), the device management apparatus may present the user with several options regarding the summary report to present the device usage data, such as, for example, shown in FIG. 7A. For example, the user may select to view the report based on the vendor (e.g., Ricoh, HP, Lexmark, Xerox, etc.). On the other hand, the user may wish to view the report based on location of the devices. In this case, the user selects to view the report based on the vendor, and thus a GUI screen, such as, for example, shown in FIG. 7B, may be presented to the user. Here, the user may view the number of devices that the organization owns according to the vendor as well as the ratio of vendor specific devices to the total amount of devices owned. In the example shown in FIG. 7B, the organization possesses 150 devices manufactured by “Ricoh” which accounts for 75% of all total devices and 4 devices manufactured by “Xerox” which accounts for 2% of all devices owned. Further, the user may be presented with previously calculated data concerning devices whose lifespan has ended. After viewing the information, the user may specify viewing vendor specific models that the organization owns by activating a corresponding “view devices” button, and consequently, a report corresponding to the selection made by the user may appear on the bottom half of the interface, such as, for example, shown in FIG. 7C.

In this case, the user has selected to view a report of “Ricoh” manufactured devices owned by the organization (e.g., “Aficio SP”, “Inkjet 89”, “Laser Nova”, “Pro C751”, etc.). Like the previous vendor report, the “Ricoh” manufactured devices report also displays similar types of information. However, in this case, the information corresponds to specific models that are manufactured by “Ricoh” and owned by the organization. The user can view a summary report of a specific model by activating the corresponding “view devices” button in the “Ricoh” manufactured devices report section which causes an interface, such as shown in FIG. 7D, to be presented to the user. In this case, the user has selected to view all “Ricoh PRO C751” devices possessed by the organization. As shown in the example of FIG. 7D, the user is presented with a summary report of five “Ricoh PRO C751” devices (i.e. “10102”, “32569”, “58745”, “85485” and “96348”) with device usage data (e.g., lifetime counter, fax count, copy count, energy usage, etc.) corresponding to each device. It should be noted that not all of the devices are the same type. In other words, some may be purely printers, other may have only a scanning function. Further, some may be a multi-functional device with certain functions removed (e.g., faxing). In such cases, the table may display a symbol “N/A” (not applicable) for device usage data that does not correspond to the device.

It should be noted that after receiving the user request to view the device usage data collected by the device management apparatus, the device management apparatus may immediately access the database for device usage data corresponding to the one or more devices (in this example, all Ricoh Aficio SP devices) that were selected by the user to view (step S604). After receiving the device usage data from the database, the device management apparatus also, in addition to presenting the user with the device usage data, determines a projected lifespan of the one or more devices by performing calculations on the received device usage data. The calculation is first performed by scaling each type of device usage data (e.g., number of service calls, machine age, fax count, etc.) since each type of device usage data has its own corresponding unit of measurement (step S605). Next, the device management apparatus inputs the device usage data into, for example, a mathematical formula [e.g., numerical lifespan index=f(x₀, x₁, x₂, . . . xₙ), where x represents each of the scaled numerical values and n is a positive integer] which outputs a numerical lifespan index that represents the lifespan of the respective device (step S606). While the numerical lifespan index is represented as a number without units in the example shown in FIG. 7D, the numerical lifespan index can be represented in any manner (e.g., percentage, number, character, etc.).

Further, the device management apparatus may display a message overlaying the device usage data table, such as, for example, shown in FIG. 7E. Such message may be presented immediately after the user has selected to view all devices owned that correspond to a single manufacturer (e.g., all devices manufactured by “Ricoh”). As shown, the user is presented with a percentage of the lifespan left of each device (e.g., 100% corresponds to full life, 0% corresponds to no life left).

In another exemplary embodiment, the user may be presented with a similar message as the one in FIG. 7E. However, in this case, the device management apparatus may cause a terminal in which the user is using (in this case, the user is accessing the functions of the device management apparatus from his or her terminal) to activate a browser on the terminal which receives a uniform resource locator (URL) from the device management apparatus to access a website containing information regarding the lifespan left of each device as shown in FIG. 7F.

In another exemplary embodiment, the user may be presented with an alternative message in which the device management apparatus informs the user which devices have reached the end of its lifespan or which devices are approaching the end of its lifespan, such as shown in the example of FIG. 7G. Such information regarding which devices are reaching the end of its lifespan may assist a user in recognizing that it is time to replace the devices before said devices no longer have any life left remaining.

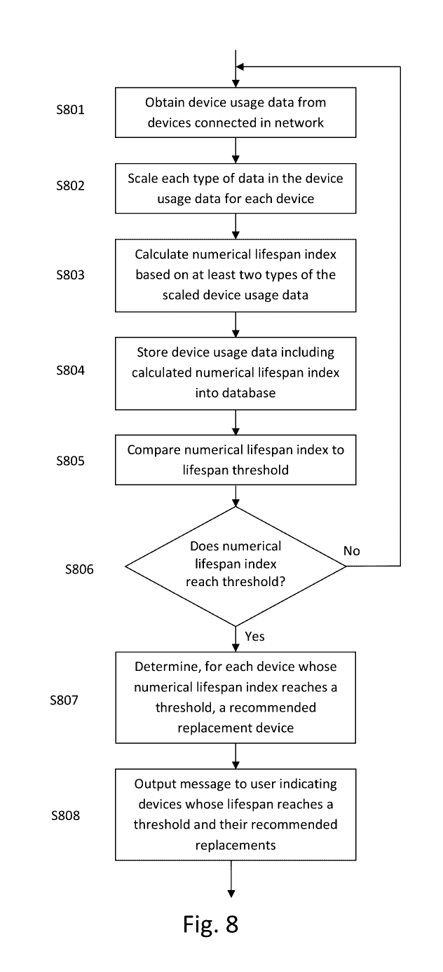

FIG. 8 shows another method performed by a device management apparatus (e.g., 101 in FIG. 1), for determining a projected lifespan of one or more devices and presenting said projected lifespan to a user, according to an exemplary embodiment.

It is not necessary that in order for the user to receive a message regarding the projected lifespan of each device (e.g., printer, MFP, copier, scanner, fax machine, etc.) in a fleet of information technology devices (each of which being connected to a network), he or she must first request information regarding device data usage of one or more particular devices. In the process illustrated by FIG. 8, a message indicating devices that have reached (or are approaching) the end of its lifespan can be sent by the device management apparatus to the user automatically.

Such process begins when the device management apparatus obtains device usage data from devices connected to the network (step S801). The device management apparatus may obtain the device usage data at periodic intervals that is set by the administrator. On the other hand, the device management apparatus may automatically receive the device usage data from the devices whenever an action (e.g., printing, copying, faxing, scanning, etc.) is performed on the device instead. Next, each type of device usage data (e.g., print count, number of service calls, energy usage, etc.) is scaled by the device management apparatus (step S802). Then, the device management apparatus calculates the numerical lifespan index of each respective device based on at least two types of the scaled device usage data (step S803). It should be noted that the device usage data is scaled due to the fact that each type of device usage data includes different units (e.g., watts, days, etc.) or may not have any units at all. Thus, by scaling the different units, there would be no error when calculating the numerical lifespan index. It should also be noted that it is not necessary to calculate the numerical lifespan index using all of the different types of device usage data. It is merely enough to just utilize two types of device usage data (e.g., service calls and energy usage) when performing the calculation. Further, any number of combinations of different types of device usage data can be used to calculate the numerical lifespan index. After calculating the numerical lifespan index, the device management apparatus stores the device usage data along with the numerical lifespan index into a database (step S804).

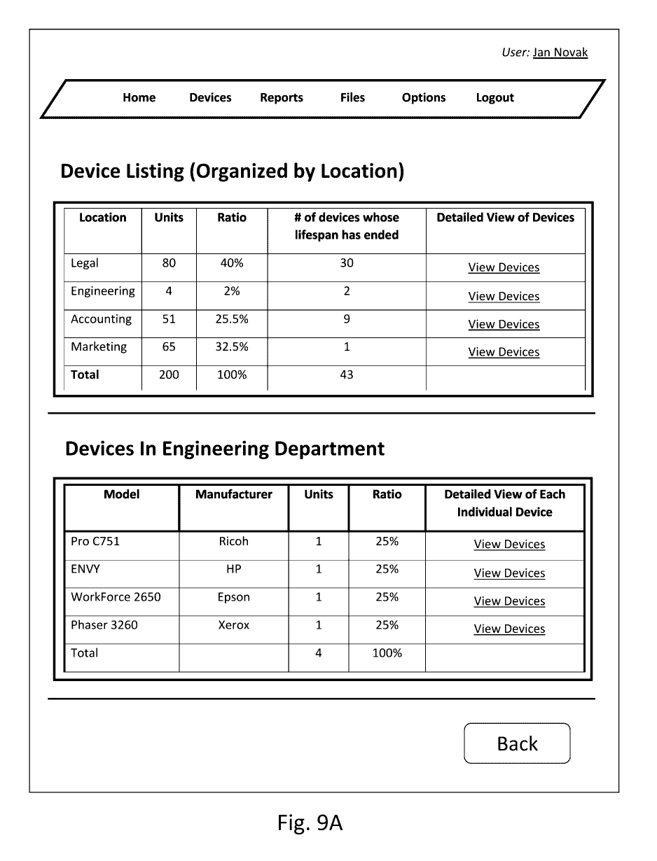

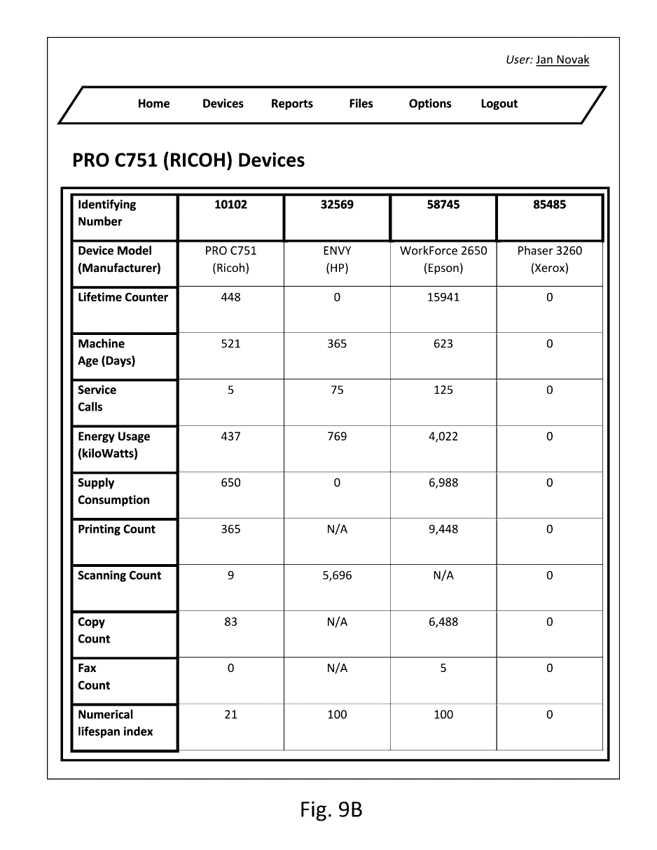

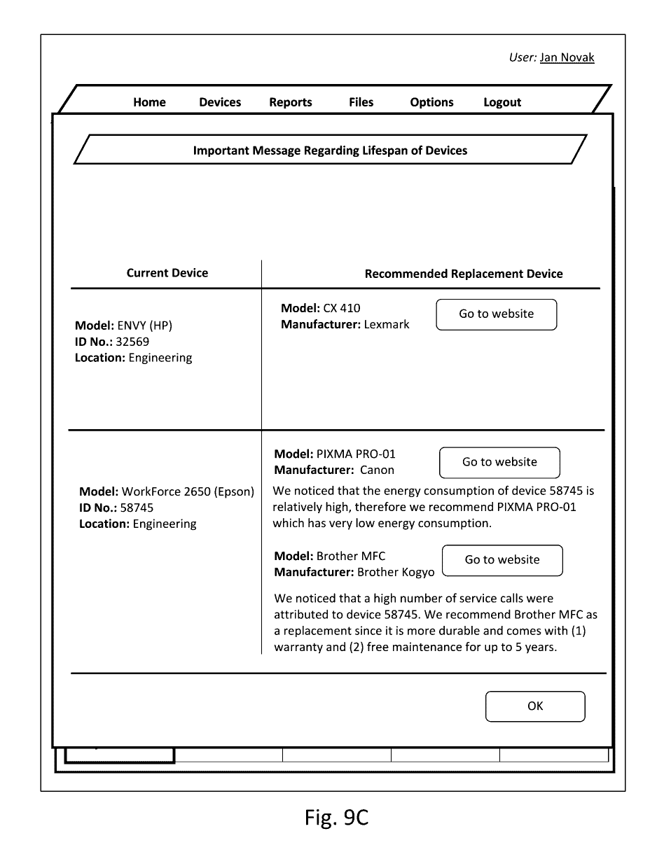

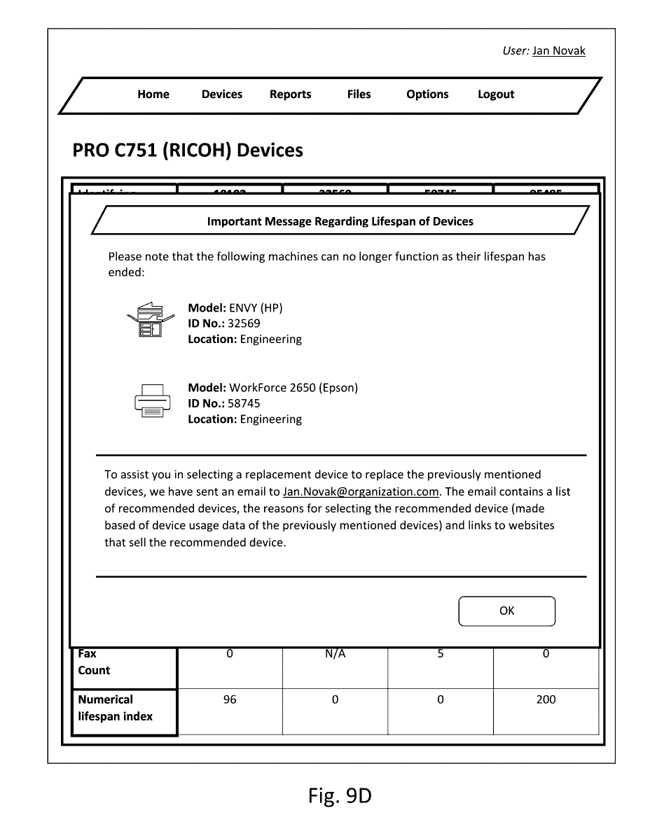

When a user access the device management apparatus, he or she may be presented with several options in how to view the device usage data collected by the device management apparatus. As shown previously in the example illustrated by FIG. 7A, the user had the option of viewing devices by vendor or by location. In this case, the user selects to view devices by location which causes an interface, such as, for example, the one shown in FIG. 9A, to be presented to the user. In the example shown in FIG. 9A, the user is presented with a summary report of the devices by their location (e.g., “legal”, “marketing”, “accounting”, etc.). In this case we assume that the departments (e.g., “legal”, “marketing”, “accounting”, etc.) are in only one location. In other words, there is only one “marketing” department and it occupies one contiguous space. Thus, in this case, the department and location are synonymous with each other. We also further note that the user has opted to view devices located in the “Engineering” department which contains four devices.

When the user activates the “View Devices” button for any of the four devices (i.e. “Pro C751”, “ENVY”, “WorkForce 2650” and “Phaser 3260”), (1) the user is presented with the interface shown in FIG. 9B and (2) the device management apparatus accesses the database for the numerical lifespan index corresponding to the devices (i.e. “Pro C751”, “ENVY”, “WorkForce 2650” and “Phaser 3260”) and compares each of the received numerical lifespan index with a corresponding predetermined lifespan threshold (step S805).

The lifespan threshold can be a predetermined numerical value that assists in determining whether the device has reached the end of its life. The threshold varies from one model of device to another and may be set by the original manufacturer of the device or by an administrator who has experience with such devices. In a case that the numerical lifespan index does not reach or passed the predetermined lifespan threshold (step S806, no), the device management apparatus continues the cycle of obtaining device usage data from each of the devices in the fleet of information technology devices.

On the other hand, in the case that the device management apparatus determines that the numerical lifespan index has indeed reached or passed the predetermined lifespan threshold (step 806, yes), the device management apparatus determines for each device whose numerical lifespan index reaches the predetermined lifespan threshold, a recommended replacement device (step S807).

In this case, the devices “ENVY (HP)” and “WorkForce 2650 (Epson)” have both reached the end of their lifespans. As a result, the device management apparatus automatically outputs a message to the user recommending one or more replacement devices (step S808), such as shown in FIG. 9C. In this case the recommendation is made based on the device usage data of the devices that are to be replaced. In other words, the device management apparatus may determine from the device usage data qualities that would be necessary or useful in a replacement device. Then the device management apparatus may search a database or a website for a device that matches those qualities. For example, as indicated by FIG. 9C, the “ENVY (HP)” device reached the end of its lifespan because its scanning function was overused. As a result, the device management apparatus searched for a replacement device that would be able to endure a greater number of scans without breaking down.

In another example, it is not necessary that the device management apparatus search for devices based on device usage data that caused the device to be replaced to reach the end of its lifespan. For example, the high energy usage may not have contributed to “WorkForce 2650 (Epson)” device reaching the end of its life. However, the device management apparatus may have noticed that this was a problem and therefore recommended a replacement device (i.e. “PIXMA PRO-01”) that consumed less energy.

In yet another example, the device management apparatus is not limited to recommending only one replacement device for one issue. The device management apparatus may, instead, recommend two or more replacement devices. In the example shown in FIG. 9C, the device management apparatus also recommended another replacement device for replacing the “WorkForce 2650 (Epson)” device. In this case, the device management apparatus recognized that there were many service calls made for the “WorkForce 2650 (Epson)” device. As a result, the device management apparatus recommended a replacement device that is more durable and that includes cost effective warranties.

In another exemplary embodiment, the user may not be shown the recommended replacement devices immediately. Instead, the device management apparatus may send the user an electronic message (e.g., email) containing the recommended devices as shown in FIG. 9D. Such action allows the user to obtain a record of the recommended devices without having to access the device management apparatus every time.

The orders in which the steps are performed in the aforementioned methods are not limited to those shown in the examples of FIGS. 6 and 8, and may be switched as long as similar results are achieved. Also, it should be noted that the methods or processes illustrated in the examples of FIGS. 6 and 8 may be implemented using the system described in connection with FIG. 1.

The aforementioned specific embodiments are illustrative, and many variations can be introduced on these embodiments without departing from the spirit of the disclosure or from the scope of the appended claims. For example, various aspects, features and advantages disclosed herein can applied to manage devices, even when the device considered for replacement does not have any print functionality.

In addition, elements and/or features of different examples and illustrative embodiments may be combined with each other and/or substituted for each other within the scope of this disclosure and appended claims.

What is claimed is:

1. A device management apparatus configured to monitor and manage a fleet of information technology devices and collect device usage data from the information technology devices via a network, said device management apparatus comprising:
a network communication module that manages communications by the device management apparatus through the network with the information technology devices;
a device data collection module that operates in cooperation with the network communication module to collect device usage data from the information technology devices and register the collected device usage data in a device database;
a device lifespan projection module that retrieves the device usage data registered in the device database for a target device amongst the managed fleet of information technology devices, and determines a projected lifespan of the target device based on at least the retrieved device usage data; and
a user interface module that causes a lifespan message corresponding to the projected lifespan of the target device to be output via the network to a user terminal, when device information of the target device is requested from the user terminal.

2. The device management apparatus as claimed in claim 1,
wherein the target device includes a print engine,
wherein the device usage data registered in the device database for the target device includes (a) a lifetime output count of pages printed by the print engine of the target device, (b) total number of service calls to service the target device, (c) energy use by the target device, and (d) consumables usage data, and
wherein the device lifespan projection module determines the projected lifespan of the target device based on at least two of the lifetime output count, the total number of service calls to service the target device, the energy use by the target device, and the consumables usage data.

3. The device management apparatus as claimed in claim 2,
wherein the device lifespan projection module determines a numerical lifespan index based on said at least two of the lifetime output count, the total number of service calls to service the target device, the energy use by the target device, and the consumables usage data, and the numerical lifespan index is displayed by the user interface module for comparison with those of other devices amongst the managed fleet of information technology devices.

4. The device management apparatus as claimed in claim 1,
wherein the projected lifespan determined by the device lifespan projection module is a numerical lifespan index of the target device, and
wherein the device lifespan projection module compares the numerical lifespan index of the target device to a lifespan threshold, and when the numerical lifespan index of the target device has reached the lifespan threshold, causes the user interface module to include in the lifespan message a recommendation to replace the target device.

5. The device management apparatus as claimed in claim 4,
wherein when the numerical lifespan index of the target device has reached the lifespan threshold, the user interface module determines, based on the device usage data, a replacement device model that is suitable as the replacement for the target device, and includes in the lifespan message an indication of the replacement device model that is a suitable replacement for the target device, in addition to the recommendation to replace the target device.

6. The device management apparatus as claimed in claim 4,
wherein the user interface module, upon request from the user terminal, generates a fleet summary report and outputs the fleet summary report to the user terminal, and the fleet summary report output to the user terminal includes, for each specified device having a numerical lifespan index that has reached the lifespan threshold, a recommendation to replace the specified device.

7. The device management apparatus as claimed in claim 4,
wherein the user interface module, upon request from the user terminal, generates a location-specific summary report for one or more managed devices associated with a specified location, and outputs the location-specific summary report to the user terminal, and the location-specific summary report output to the user terminal includes, for each specified device amongst said one or more managed devices having a numerical lifespan index that has reached the lifespan threshold, a recommendation to replace the specified device.

8. The device management apparatus as claimed in claim 4,
wherein the user interface module, upon request from the user terminal, generates a vendor-specific summary report for one or more managed devices associated with a specified vendor, and outputs the vendor-specific summary report to the user terminal, and the vendor-specific summary report output to the user terminal includes, for each specified device amongst said one or more managed devices having a numerical lifespan index that has reached the lifespan threshold, a recommendation to replace the specified device.

9. The device management apparatus as claimed in claim 1,
wherein the user interface module, upon request from the user terminal, generates a meter read report and outputs the meter read report to the user terminal, and the meter read report output to the user terminal includes, for each specified device that includes a print engine, (i) a metered page count output by the specified device within a predetermined period and (ii) a lifespan message specific to said specified device.

10. The device management apparatus as claimed in claim 1,
wherein the user interface module, upon request from the user terminal, generates a usage report and outputs the usage report to the user terminal, and the usage report output to the user terminal includes, for each specified device, (i) the device usage data of the specified device and (ii) a lifespan message specific to the specified device.

11. The device management apparatus as claimed in claim 1,
wherein the projected lifespan determined by the device lifespan projection module is a numerical lifespan index of the target device, and
wherein when the numerical lifespan index of the target device to a lifespan threshold has reached a lifespan threshold, the user interface module determines, based on the device usage data, a replacement device model that is suitable as a replacement for the target device, and the user interface module sends to a registered address an electronic message including (i) a recommendation to replace the target device and (ii) an indication of the replacement device model that is a suitable replacement for the target device.

12. The device management apparatus as claimed in claim 1,
wherein the lifespan message output by the user interface module includes an indication of a percentage of the lifespan of the target device remaining.

13. The device management apparatus as claimed in claim 1,
wherein the projected lifespan determined by the device lifespan projection module is a numerical lifespan index of the target device, and
wherein when the numerical lifespan index of the target device to a lifespan threshold has reached a lifespan threshold, the user interface module sends to a registered address an electronic message including a recommendation to replace the target device.

14. The device management apparatus as claimed in claim 1,
wherein the user interface module, upon request, outputs a web page through the network to the user terminal to cause a web browser application on the user terminal to provide a graphical user interface (GUI) on the user terminal, and
wherein the lifespan message corresponding to the projected lifespan of the target device is provided through the GUI on the user terminal.

15. The device management apparatus as claimed in claim 1,
wherein the device management apparatus provides a device management application through the network to the user terminal, and the user interface module causes the device management application to provide a graphical user interface (GUI) on the user terminal, and
wherein the lifespan message corresponding to the projected lifespan of the target device is provided through the GUI on the user terminal.

16. A method performed by a device management apparatus to monitor and manage a fleet of information technology devices, said method comprising:
communicating by the device management apparatus through a network with the information technology devices, and collecting device usage data from the information technology devices via the network;
registering the collected device usage data in a device database;
retrieving the device usage data registered in the device database for a target device amongst the managed fleet of information technology devices, and determining, by the device management apparatus, a projected lifespan of the target device based on at least the retrieved device usage data; and
communicating by the device management apparatus through a network with a user terminal and causing a user interface on the user terminal to output a lifespan message corresponding to the projected lifespan of the target device, when device information of the target device is requested from the user terminal.

17. The method of claim 16, further comprising:
comparing the projected lifespan of the target device to a lifespan threshold, wherein the projected lifespan is a numerical lifespan index of the target device; and
causing the user interface to output a recommendation to replace the target device, when the numerical lifespan index of the target device has reached the lifespan threshold.

18. The method of claim 17, further comprising:
determining, by the device management apparatus based on the device usage data, a replacement device model that is suitable as a replacement for the target device, when the numerical lifespan index of the target device has reached the lifespan threshold; and
causing the user interface to output in the lifespan message an indication of the replacement device model that is a suitable replacement for the target device, in addition to the recommendation to replace the target device.
